(19) United States
(12) Patent Application Publication
(10) Pub. No.: US 2013/0323537 A1
(43) Pub. Date: Dec. 5, 2013

(54) NON-AQUEOUS ELECTROLYTE BATTERY AND PACK BATTERY

(71) Applicants: Takuya IWASAKI, Uenohara-shi (JP); Hiroki Inagaki, Yokohama-shi (JP); Norio Takami, Yokohama-shi (JP)

(72) Inventors: Takuya IWASAKI, Uenohara-shi (JP); Hiroki Inagaki, Yokohama-shi (JP); Norio Takami, Yokohama-shi (JP)

(21) Appl. No.: 13/729,661

(22) Filed: Dec. 28, 2012

(30) Foreign Application Priority Data
May 31, 2012 (JP) 2012-124471

(51) Int. Cl. H01M 10/05

(52) U.S. Cl. CPC H01M 10/05
USPC 429/7; 429/163

(57) ABSTRACT

According to one embodiment, a non-aqueous electrolyte battery includes an outer package, a positive electrode, a negative electrode, and a non-aqueous electrolyte, wherein the negative electrode includes a current collector and a negative electrode layer formed on at least one surface of the current collector, and the negative electrode layer includes a titanium oxide compound having a crystal structure of monoclinic titanium dioxide as an active material and a non-fluororesin, the titanium oxide compound being modified with at least one ion selected from alkali metal cations.

### CROSS-REFERENCE TO RELATED APPLICATIONS

This application is based upon and claims the benefit of priority from Japanese Patent Application No. 2012-124471, filed May 31, 2012, the entire contents of which are incorporated herein by reference.

### FIELD

Embodiments described herein relate generally to a non-aqueous electrolyte battery and a pack battery.

### BACKGROUND

A non-aqueous electrolyte battery provided with a negative electrode containing titanium oxide as an active material enables stable and boosting charge/discharge. This battery has a longer life than a battery provided with a negative electrode containing a carbon type active material. However, titanium oxide has a higher potential (nobler) than a carbonaceous material with respect to metal lithium and a lower capacity per weight. For this, a non-aqueous electrolyte battery containing titanium oxide as an active material has a lower energy density.

The potential of titanium oxide is limited electrochemically, because the potential of titanium oxide is caused by a redox reaction between Ti³⁺ and Ti⁴⁺ when lithium is intercalated and desorbed electrochemically. Further, there is the fact that boosting charge/discharge of lithium ions can be accomplished stably at an electrode potential as high as 1.5 V. Therefore, it is substantially difficult to improve energy density by shifting the negative electrode potential to the lower potential side.

As to the theoretical capacity of titanium oxide, the theoretical capacity of titanium dioxide (anatase structure) is about 165 mAh/g, and the theoretical capacity of spinel type lithium-titanium complex oxide represented by the formula Li₄Ti₅O₁₂ is about 170 mAh/g. In contrast, the theoretical capacity of a carbon (graphite) type electrode material is 385 mAh/g or more. As mentioned above, the capacity density of titanium oxide is significantly lower than that of a carbon type negative electrode. This reason is that the number of lithium-absorbing equivalent sites is few in the crystal structure of titanium oxide and lithium is easily stabilized in the structure, bringing about a reduction in substantial capacity.

In light of the above situation, monoclinic titanium dioxide having a higher theoretical capacity than the above titanic acid compound has attracted remarkable attention in recent years (see, R. Marchand, L. Brohan, M. Tournoux, Material Research Bulletin 15, 1129 [1980]). The number of lithium ions per titanium ion which can be intercalated and desorbed in monoclinic titanium dioxide is a maximum of 1.0. As a result, the monoclinic titanium dioxide has a theoretical capacity as high as about 330 mAh/g.

For example, JP-A 2008-034368 (KOKAI) discloses a lithium ion storage battery using titanium oxide TiO₂ having a bronze type structure as the negative electrode active material. Further, JP-A 2008-117625 (KOKAI) discloses a lithium secondary battery using, as the negative electrode active material, titanium dioxide having a titanic acid bronze type crystal structure.

In the case of using a monoclinic titanium dioxide as the negative electrode active material, however, the performance of a battery is significantly deteriorated, leading to a shorter life.

In light of this, JP-A 2011-048947 (KOKAI) discloses a negative electrode obtained by forming a negative electrode layer comprising, for example, an active material obtained by modifying the surface of titanium dioxide having a titanic acid bronze type crystal structure with an alkali metal cation and a fluororesin as a binder, on a current collector. The life of a battery can be improved by using this negative electrode.

However, the pH of titanium dioxide exceeds about 8 when the surface of titanium dioxide is modified with an alkali metal cation. Therefore, when a negative electrode is manufactured by blending a fluororesin with modified titanium dioxide to prepare a slurry and by applying the slurry to at least one surface of a current collector, followed by drying to form a negative electrode layer, a dehydrofluorination reaction of the fluororesin occurs in an alkaline condition at a pH exceeding about 8, allowing the progress of the gelation of the slurry. As a result, the binding strength between the negative electrode layer and current collector is reduced, leading to reduction in the life of a non-aqueous electrolyte battery.

### BRIEF DESCRIPTION OF THE DRAWINGS

FIG. 1 is a typical view showing the crystal structure of monoclinic titanium dioxide;

FIG. 2 is a sectional view of a flat type non-aqueous electrolyte battery according to a first embodiment;

FIG. 3 is an enlarged sectional view of the part A in FIG. 2;

FIG. 4 is an exploded perspective view of a pack battery according to a second embodiment; and

FIG. 5 is a block diagram showing the electric circuit of a pack battery of FIG. 4.

### DETAILED DESCRIPTION

### First Embodiment

In general, according to a first embodiment, a non-aqueous electrolyte battery includes an outer package, a positive electrode housed in the outer package, a negative electrode housed in the outer package in such a manner as to be spaced apart from the positive electrode through, for example, a separator, and a non-aqueous electrolyte filled in the outer package. The negative electrode comprises a current collector and a negative electrode layer formed on at least one surface of the current collector. The negative electrode layer comprises, as an active material, a titanium oxide compound having a monoclinic titanium dioxide crystal structure and a non-fluororesin. The titanium oxide compound having a monoclinic titanium dioxide crystal structure is modified with at least one ion selected from alkali metal cations.

The titanium oxide compound having a monoclinic titanium dioxide crystal structure has a highly reactive solid acid point (for example, a hydroxyl group [OH⁻] and a hydroxyl group radical [OH.]) on it's surface and also acts as a solid catalyst. When this titanium oxide compound is used as a negative electrode active material, it has high reactivity with the non-aqueous electrolyte. Therefore, the above titanium oxide compound reacts with the non-aqueous electrolyte after a coating film is once formed on the surface of the titanium oxide compound. As a result, a non-aqueous electrolyte battery provided with a negative electrode containing the above titanium oxide compound as an active material has a shorter life by causing a rise in internal resistance and deterioration in the non-aqueous electrolyte, for example. When, particularly, a trace amount of water exists, the in-water solid acidity of the monoclinic titanium dioxide crystal structure in the above titanium oxide compound is promoted. In this case, the in-water solid acidity is measured by a pH value at which 2 g of a titanium oxide compound powder is added at 25° C. to 100 g of pure water and stirring for 5 minutes. Water is possibly presented in the raw material production processes and battery fabrication processes and it is difficult to chemically perfectly remove water from the viewpoint of the property of the raw materials and costs.

From the facts mentioned above, the titanium oxide compound having a monoclinic titanium dioxide crystal structure is modified with at least one ion selected from alkali metal cations and inactivates solid acid points (catalyst active points). Therefore, the reaction between the titanium oxide compound and non-aqueous electrolyte can be suppressed. As a result, in a non-aqueous electrolyte battery provided with a negative electrode containing the above modified titanium oxide compound as the negative electrode active material, the rise of internal resistance and deterioration of a non-aqueous electrolyte are suppressed and therefore, a good repeated life performance can be achieved. Further, since the solid acid point is inactivated, a reversible capacity is reduced, so that the first charge/discharge efficiency is improved.

However, in the subsequent studies made by the inventors, it has been made clear that when a titanium oxide compound is modified with at least one ion selected from alkali metal cations, the pH exceeds 8. Therefore, when a fluororesin is used as a binder to form a negative electrode layer containing the fluororesin together with the above modified titanium oxide compound, the above fluororesin is chemically deteriorated under an alkaline condition exceeding pH 8 and the adhesion between the negative electrode layer and current collector are damaged.

In light of this, the inventors ensure that when a non-fluorine type resin as the binder contains in the negative electrode layer together with the above modified titanium oxide compound, the chemical deterioration of the binder can be prevented even if the pH of the modified titanium oxide compound exceeds 8. Therefore, the adhesion between the negative electrode layer and current collector can be improved. As a result, a non-aqueous electrolyte battery provided with such a negative electrode is improved in cycle life.

The outer package, positive electrode, negative electrode, and non-aqueous electrolyte, and separator which constitute the non-aqueous electrolyte battery according to the first embodiment will be explained.

1) Outer Package

The outer package may be used a bag made of a laminate film 0.5 mm or less in thickness or a metal container 1 mm or less in thickness. The thickness of the laminate film is more preferably 0.2 mm or less. The metal container has a thickness of, preferably, 0.5 mm or less, and more preferably 0.2 mm or less.

The shape of the outer package may be, for example, a flat type (thin type), angular type, cylinder type, coin type or button type. The outer package may be, for example, outer packages for miniature batteries to be mounted on, for example, mobile electronic devices or outer packages for large batteries to be mounted on two- or four-wheel vehicles corresponding to the dimension of the battery.

The laminate film may be used a multilayer film prepared by interposing a metal layer between resin layers. The metal layer is preferably formed of an aluminum foil or aluminum alloy foil to reduce the weight of the battery. The resin layer is made of polymer materials such as a polypropylene (PP), polyethylene (PE), nylon and polyethylene terephthalate (PET). The laminate film can be molded into the shape of the outer package by sealing through thermal fusion.

The metal container is made of aluminum, an aluminum alloy or the like. The aluminum alloy is preferably an alloy containing elements such as magnesium, zinc, and silicon. When the alloy contains transition metals such as iron, copper, nickel and chromium, the amount of the transition metals is preferably 1 mass % or less. The container formed of aluminum or an aluminum alloy is outstandingly improved in long-term reliability and radiation ability.

2) Positive Electrode

The positive electrode comprises a current collector and a positive electrode layer which is formed on at least one surface of the current collector and contains an active material and a binder.

The active material may be used, for example, oxides, sulfides, or polymers. Examples of the oxides include those which absorb lithium, for example, manganese dioxide (MnO₂), iron oxide, copper oxide, nickel oxide, lithium-manganese complex oxides (for example, Liₓ Mn₂O₄ or Liₓ MnO₂), lithium-nickel complex oxides (for example, LiₓNiO₂), lithium-cobalt complex oxides (for example, LiₓCoO₂), lithium-nickel-cobalt complex oxides (for example, LiNi_{1-y}Co_{y}O₂), lithium-manganese-cobalt complex oxides (for example, Liₓ Mn_{y}Co_{1-y}O₂), spinel type lithium-manganese-nickel complex oxides (for example, Liₓ Mn_{2-y}Ni_{y}O₄), lithium-phosphorous oxide having an olivine structure (for example, LiₓFePO₄, LiₓFe_{1-y} Mn_{y}PO₄, and LiₓCoPO₄), iron sulfate (Fe₂(SO₄)₃), vanadium oxides (for example, V₂O₅) and lithium-nickel-cobalt-manganese complex oxides. In the formulas, x and y are 0<x≦1 and 0<y≦1, respectively.

The polymer may be used, for example, conductive polymer materials such as a polyaniline and polypyrrole, or disulfide type materials. Sulfur (S) or fluorocarbon may also be used as the active material.

The active material may be preferably used those having a high positive electrode voltage, for example, lithium-manganese complex oxides (Liₓ Mn₂O₄), lithium-nickel complex oxides (LiₓNiO₂), lithium-cobalt complex oxides (LiₓCoO₂), lithium-nickel-cobalt complex oxides (LiNi_{1-y}Co_{y}O₂), spinel type lithium-manganese-nickel complex oxides (Liₓ Mn_{2-y}Ni_{y}O₄), lithium-manganese-cobalt complex oxides (Liₓ Mn_{y}Co_{1-y}O₂), lithium-iron phosphate (LiₓFePO₄), and lithium-nickel-cobalt-manganese complex oxides. In the formulas, x and y are 0<x≦1 and 0<y≦1, respectively.

When a non-aqueous electrolyte containing a cold molten salt is used, lithium-iron phosphate, LiₓVPO₄F, lithium-manganese complex oxide, lithium-nickel complex oxide and lithium-nickel-cobalt complex oxide are preferably used in view of cycle life. This is because the positive electrode active material is less reactive with the cold molten salt.

Preferably, the specific surface area of the active material is 0.1 to 10 m²/g. The active material having a specific surface area of 0.1 m²/g or more is capable of securing lithium ion-absorption/release sites sufficiently. The active material having a specific surface area of 10 mm²/g or less is easily handled in industrial production and can also secure good charge/discharge cycle performance.

The binder is formulated to bind the active material with the current collector. Examples of the binder include a polytetrafluoroethylene (PTFE), polyvinylidene fluoride (PVdF) and fluoro-rubber.

The conductive agent is formulated according to the need to improve the current collecting ability of the active material and to reduce the contact resistance between the active material and the current collector. Examples of the conductive agent include carbonaceous materials such as acetylene black, carbon black, and graphite.

The active material and binder in the positive electrode layer are preferably formulated in ratios of 80% by mass to 98% by mass and 2% by mass to 20% by mass, respectively.

When the amount of the binder is designed to be 2% by mass or more, sufficient positive electrode strength can be obtained. When the amount of the binder is 20% by mass or less, the amount of an insulation material in the electrode can be reduced, making it possible to reduce internal resistance.

When the conductive agent is added, the active material, binder and conductive agent are preferably formulated in ratios of 77% by mass to 95% by mass, 2% by mass to 20% by mass and 3% by mass to 15% by mass, respectively. The conductive agent can achieve the aforementioned effect by blending it in an amount of 3% by mass or more. The decomposition of the non-aqueous electrolyte on the surface of the conductive agent can be reduced by blending it in an amount of 15% by mass or less when the non-aqueous electrolyte is stored at high temperature.

The current collector is preferably made of an aluminum foil or aluminum alloy foil containing at least one element selected from Mg, Ti, Zn, Ni, Cr, Mn, Fe, Cu and Si.

The thickness of the aluminum foil or aluminum alloy foil is preferably 5 μm to 20 μm and more preferably 15 μm or less. The purity of the aluminum foil is 99% by mass or more. The content of transition metals such as iron, copper, nickel and chromium contained in the aluminum foil or aluminum alloy foil is preferably designed to be 1% by mass or less.

The positive electrode can be manufactured by suspending, for example, the active material and binder and the conductive agent which is added as required, in a proper solvent to prepare slurry, by applying this slurry to the surface of the positive electrode current collector and by drying the slurry to form a positive electrode layer, followed by pressing. The positive electrode may also be manufactured by forming the active material and binder and the conductive agent which is added as required as a pellet, to produce a positive electrode layer, and forming the pellet on the current collector.

3) Negative Electrode

The negative electrode comprises a current collector and a negative electrode layer which is formed on at least one surface of the current collector and contains an active material, a conductive agent, and a binder.

The active material contains a titanium oxide compound having a monoclinic titanium dioxide crystal structure modified by at least one ion selected from alkali metal cations.

Here, the monoclinic titanium dioxide is referred to as TiO₂(B). The crystal structure of TiO₂(B) primarily belongs to the space group C2/m though there is the case where the crystal structure belongs to a different space group because a strain is generated depending on the amount of intercalation or its type. The crystal structure of TiO₂(B) has a tunnel structure shown in FIG. 1. The details of the crystal structure of TiO₂(B) are described in R. Marchand, L. Brohan, M. Tournoux, Material Research Bulletin 15, 1129 (1980) mentioned above.

In the crystal structure of TiO₂(B) shown in FIG. 1, a titanium ion 51 and an oxide ion 52 constitute a skeleton structure part 53a. The skeleton structure parts 53a are combined with each other and continuous. A void part 53b exists between the skeleton structure parts 53a. The void part 53b can become host sites for intercalation of heteroatoms.

In TiO₂(B), host sites enabling intercalation and desorption of heteroatoms exist on the surface of the crystal. TiO₂(B) can reversibly absorb/release lithium ions through these host sites.

When lithium ions are inserted into the void part 53b, Ti⁴⁺ constituting the skeleton is reduced to Ti³⁺ and the electric neutrality of the crystal is thereby maintained. Because TiO₂(B) has one Ti⁴⁺ per chemical formula, a maximum of one lithium ion can be theoretically intercalated between layers. Therefore, a titanium oxide compound having the crystal structure of TiO₂(B) can be represented by the formula LiₓTiO₂ (0≦x≦1). This titanium oxide compound has a theoretical capacity near two times that of conventional titanium oxide.

Such a crystal structure of TiO₂(B) exhibits solid acidity which shows a pH of 1 or more and less than 7 in water. A titanium oxide compound having a crystal structure of TiO₂(B) is modified by an alkali cation to inactivate the solid acid points (catalyst active points), thereby making it possible to limit the deterioration of a cycle life performance.

The surface of the titanium oxide compound as the active material is modified, so that the catalyst activity is deactivated. Here, the modification of the titanium oxide compound with the alkali metal cation means that the alkali metal cation is bonded or substituted with the solid acid points on its surface, thereby inactivating the solid acid points. The alkali metal cation is chemically bonded with the surface of the titanium oxide compound and does not exist independently.

In this case, all solid acid points are unnecessarily inactivated but it is only necessary that at least a part of these solid acid points are inactivated.

The alkali metal cation is preferably selected from a Li element, Na element, and K element, and more preferably selected from Li⁺, Na⁺, and K⁺. Such a modifying element has high stability, does not affect charge/discharge conditions, and also has no adverse influent on the positive electrode, and is therefore preferable.

Although no particular limitation is imposed on whether the alkali metal cation is present or absent and the amount of the alkali metal cation, it is preferable that the alkali metal cation be primarily present on the surface of the titanium oxide compound in order to inactivate the solid acidity points. An atomic ratio of an oxygen to an alkali metal in the titanium oxide compound modified with the at least one ion is 0.12 to 0.90 (alkali metal): 1 (oxygen) when the modified titanium oxide compound is analyzed using X-ray photoelectron spectroscopy (XPS).

When the alkali metal is Li, the electrode is measured a condition in which mobile Li is not present after it has been completely discharged.

The titanium oxide compound preferably has the characteristics that the aspect ratio is 1 to 50, the length in the direction of the minor axis is 0.1 to 50 μm, and the length in the direction of the major axis is 0.1 to 200 μm.

The aspect ratio, and the lengths in the directions of the major axis and minor axis can be altered corresponding to the battery characteristics to be required. In the case where, for example, boosting charge/discharge is required, the aspect ratio may be designed to be 1 and the lengths in the directions of the major axis and minor axis may be respectively about 0.1 μm. Because such a titanium oxide compound is reduced in the diffusion resistance of Li ions in the solid, it is advantageous in boosting charge/discharge. If the aspect ratio is small, the contact area with the electrolyte is increased, so that the reaction with the electrolyte is promoted, and it is therefore possible to produce the effect of an embodiment more effectively.

When a high capacity is required, in contrast, it is preferable that the aspect ratio, the length in the direction of the minor axis, and the length in the direction of the major axis are 10 or more, about 5 μm, about 50 to 200 μm, respectively. Such a titanium oxide compound may be designed intentionally to increase a plane orthogonal to the direction of the minor axis, that is, the (001) plane is an orientation plane in the pressing process when producing the negative electrode. The (001) plane in TiO₂(B) is a plane which allows easy intercalation/desorption of Li ions. As a result, a negative electrode can be obtained which has many crystal planes advantageous for the intercalation/desorption of Li ions.

When the lengths in the directions of the major axis and minor axis are respectively designed 0.1 μm or more, the contact area with the non-aqueous electrolyte is not increased too greatly and good crystallinity is obtained. When the length of the major axis is 200 μm or less, dispersibility in a solvent is good and therefore, slurry for the production of the negative electrode can be stabilized.

The lengths in the directions of the major axis and minor axis can be measured by a direct observation using an electron microscope. The average length can be obtained by measuring a grain size distribution according to the laser diffraction method.

The titanium oxide compound preferably has a BET specific surface area of 5 to 100 m²/g. When the specific surface area is 5 m²/g or more, the contact area with the non-aqueous electrolyte can be secured. In contrast, when the specific surface area is 100 m²/g or less, reactivity with the non-aqueous electrolyte is not too high and therefore, life characteristics can be improved. Further, the coating of slurry is easily accomplished in the process of producing the negative electrode.

In the measurement of the specific surface area, it is used a method in which a molecule, the area occupied by its adsorption is known, is made to adsorb to the surface of powder particles at a liquid nitrogen temperature to find the specific surface area of a sample from the amount of the molecule to be adsorbed. In this method, the BET method based on low-temperature and low-humidity physical adsorption of inert gas is most commonly used. This BET method is based on the well known monolayer adsorption theory developed, by extending the Langmuir theory, to address multilayer adsorption and used as the method of calculating specific surface area. The specific surface area obtained by this method is called “BET specific surface area”.

The modified titanium oxide compound of which the solid acid points are inactivated may have a form of primary particle or a form of secondary particle obtained by coagulation of primary particles. The modified titanium oxide compound is preferably made of secondary particles from the viewpoint of the stability of the slurry to be used for the production of a negative electrode. These secondary particles have a relatively small specific surface area and therefore, side reactions with the electrolyte solution can be suppressed when the negative electrode is used.

Although the aforementioned modified titanium oxide compound may be used independently as the active material, it may be used as a mixture with other active materials. Examples of these other active materials include anatase type titanium dioxide, Li₂Ti₃O₇ which is rhamsdelite type lithium titanate, and Li₄Ti₅O₁₂ which is a spinel type lithium titanate. Because these titanium oxide compounds each have a specific gravity close to that of the aforementioned modified titanium oxide compound and are easily mixed and dispersed, they are preferably used. The ratio of these titanium oxide compounds to be blended is preferably 5% by mass or less. The ratio of these titanium oxide compounds to be blended is more preferably 1% by mass or less from the viewpoint of high capacitization.

The conductive agent is formulated to improve the current-collecting performance and to reduce the contact resistance with the current collector. Examples of the conductive agent include carbon type materials such as cokes, carbon black, and graphite. The average particle diameter of the carbon type material is preferably 0.1 to 10 μm. When the average particle diameter is designed to be 0.1 μm or more, the generation of gas can be limited effectively. When the average particle diameter is designed to be 10 μm or less, a good conductive network is obtained. The specific surface area of the carbon type material is preferably 10 to 100 m²/g. When the specific surface area is designed to be 10 m²/g or more, a good conductive network is obtained. When the specific surface area is designed to be 100 m²/g or less, the generation of gas can be limited effectively.

The conductive agent improves the current-collecting performance of the active material and limits the contact resistance with the current collector. Examples of the conductive agent include carbonaceous materials such as acetylene black, carbon black, and graphite.

Because a modified titanium oxide compound is used as the active material in the first embodiment as mentioned above, a non-fluororesin is selected as the binder. The binder is formulated to fill clearances between the dispersed active materials and binds the active material with the conductive agent. The non-fluororesin is preferably, for example, a polyacrylic acid, carboxymethyl cellulose, or hydroxypropylmethyl cellulose. These non-fluororesins may be polymers or copolymers. Further, the non-fluororesin may include both of these polymers and copolymers or a combination of these polymers or copolymers.

Examples of the monomers constituting the polyacrylic acid include monomers containing an acryl group and monomers containing a methacryl group. The monomers having an acryl group are typically acrylic acids or acrylates. The monomers containing a methacryl group are typically methacrylic acids or methacrylates.

Examples of the monomers constituting the polyacrylic acids include ethylacrylate, methylacrylate, butylacrylate, 2-ethylhexylacrylate, isononylacrylate, hydroxyethylacrylate, methylmethacrylate, glycidylmethacrylate, acrylonitrile, acrylamide, styrene, and acrylamide.

The active material, conductive agent and binder contained in the negative electrode layer are preferably formulated in ratios of 68% by mass or more and 96% by mass or less, 2% by mass or more and 30% by mass or less, and 2% by mass or more and 30% by mass or less, respectively. When the amount of the conductive agent is 2% by mass or more, the current collecting performance of the negative electrode layer is good. Further, when the amount of the binder is 2% by mass or more, the binding ability between the negative electrode layer and the current collector is satisfactory and excellent cycle characteristics can be expected. In contrast, the amount of the binder is preferably designed to be 30% by mass or less to develop a high-capacity non-aqueous electrolyte battery.

For the current collector, a material which is electrochemically stable at the lithium absorption and release potential of the negative electrode active material is used. The current collector is preferably made of copper, nickel, stainless, or aluminum, or aluminum alloys containing elements such as Mg, Ti, Zn, Mn, Fe, Cu and Si. The thickness of the current collector is preferably 5 to 20 μm. The current collector having such a thickness can be well balanced between the strength of the negative electrode and lightness.

The negative electrode may be manufactured by suspending the active material, conductive agent and binder in a general solvent to prepare slurry, which is applied to the current collector and dried to form a negative electrode layer, followed by pressing the negative electrode layer. Further, the negative electrode may be manufactured by making the active material, conductive agent and binder into a pellet-like form to thereby produce a negative electrode layer which is formed on the current collector.

Next, a method of producing the modified titanium oxide compound contained in the active material will be explained.

The method of producing a titanium oxide compound involves a step of reacting an alkali titanate compound with an acid to replace alkali cations with protons to obtain a proton exchange body, a step of heat-treating the proton exchange body to create a titanium oxide compound having a monoclinic titanium dioxide crystal structure, and a step of modifying the titanium oxide compound by using a compound containing at least one ion selected from alkali metal cations.

Specifically, first, the alkali titanate compound is washed with distilled water to remove impurities. After that, an acid is reacted with the alkali titanate compound to replace alkali cations of the alkali titanate compound with protons to obtain a proton exchange body. The alkali cations of the alkali titanate compound can be replaced with protons without disintegrating the crystal structure by treating with an acid.

As the alkali titanate compound, compounds, for example, sodium titanate (for example, Na₂Ti₃O₇), potassium titanate (for example, K₂Ti₄O₉), and cesium titanate (for example, Cs₂Ti₅O₁₂) may be used. These alkali titanate compounds may be obtained by a general solid reaction method in which a raw material oxide or carbonate is blended in a specified stoichiometric ratio and heated. No particular limitation is imposed on the crystal shape of the alkali titanate compound. Further, the alkali titanate compound is not limited to those synthesized by the aforementioned method and may be a commercially available one.

In the acid treatment for proton exchange, an acid such as hydrochloric acid, nitric acid, or sulfuric acid having a concentration of 0.5 to 2 M can be used.

The acid treatment may be performed by adding an acid to a powder of the alkali titanate compound and by stirring the mixture. The acid treatment is preferably continued until alkali cations are sufficiently replaced with protons. If alkali cations such as potassium and sodium ions are left unremoved in the proton exchange body, this is a cause of reduced charge/discharge capacity. Therefore, the acid treatment is intended to replace almost all alkali cations with protons.

Although no particular limitation is imposed on the time for acid treatment, the acid treatment is preferably continued for 24 hours or more and more preferably 1 to 2 weeks in the case of using hydrochloric acid having a concentration of about 1 M at an ambient temperature of about 25° C. It is also preferable to replace the acid solution with a new one every 24 hours.

Then, after the proton exchange is finished, an alkaline solution such as an aqueous lithium hydroxide solution is optionally added to neutralize the residual acid. The obtained proton exchange body is washed with distilled water and dried. The proton exchange body is sufficiently washed with water until the pH of the washed water falls within a range from 6 to 8.

Then, the proton exchange body is heat-treated to obtain a titanium oxide compound having a crystal structure of TiO₂(B). The heat treatment is preferably carried out by sintering. Because an optimum sintering temperature differs depending on the condition such as the composition, particle diameter and crystal form of the proton exchange body, it is properly determined depending on the proton exchange body. For example, the sintering temperature is preferably designed to be 300 to 500° C. When the sintering temperature is 300° C. or more, the crystallinity is good and also, the capacity of the negative electrode, charge/discharge efficiency, and repeated characteristics are good. When the sintering temperature is 500° C. or less, in contrast, the creation of anatase type titanium dioxide which is an impurity phase is suppressed and therefore, reduction in the capacity of the negative electrode can be prevented. When the sintering temperature is in a range of 350 to 400° C., the obtained titanium oxide compound is more preferable because the obtained titanium oxide compound has a higher capacity. Preferable heating time is, for example, in a range from 2 to 3 hours, though the heating time is not limited to this.

Then, the obtained titanium oxide compound is modified with a compound containing at least one ion selected from alkali metal cations (for example, Li⁺, Na⁺, and K⁺) to inactivate solid acid points existing on the surface of the titanium oxide compound.

The modification can be attained by adding an inorganic compound containing the above ions to a titanium oxide compound powder. For instance, a water soluble inorganic compound containing the above ions is dissolved in pure water and the titanium oxide compound is dispersed in this solution. The dispersion solution is then filtered to separate a solid, and then the solid is washed with water and dried. Such a treatment ensures the production of a titanium oxide compound in which the solid acid points are inactivated, that is, a modified titanium oxide compound. In the modified titanium oxide compound, the solid acid points are bonded or substituted with a modifying element, and this modified element is not desorbed even by washing with water.

4) Non-Aqueous Electrolyte

Examples of the non-aqueous electrolyte include liquid non-aqueous electrolytes prepared by dissolving an electrolyte in an organic solvent and gel organic electrolytes obtained by making a complex of a liquid electrolyte and a polymer material.

The liquid non-aqueous electrolyte is preferably prepared by dissolving an electrolyte in a concentration of 0.5 to 2.5 mol/L in an organic solvent.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethasulfonate (LiCF₃SO₃) and bistrifluoromethylsulfonylimide lithium [LiN(CF₃SO₂)₂] and mixtures of these lithium salts. The electrolyte is preferably resistant to oxidation at a high potential and LiPF₆ is more preferable.

Examples of the organic solvent include cyclic carbonates such as propylene carbonate (PC), ethylene carbonate (EC) and vinylene carbonate; chain carbonates such as diethyl carbonate (DEC), dimethyl carbonate (DMC) and methyl ethyl carbonate (MEC); cyclic ethers such as tetrahydrofuran (THF), 2-methyltetrahydrofuran (2 MeTHF), and dioxolan (DOX); chain ethers such as dimethoxyethane (DME) and diethoxyethane (DEE); γ-butyrolactone (GBL), acetonitrile (AN), and sulfolane (SL). These organic solvents may be used either singly or in combinations of two or more.

Examples of the polymer include a polyvinylidene fluoride (PVdF), polyacrylonitrile (PAN), and polyethylene oxide (PEO).

In this case, as the non-aqueous electrolyte, a cold molten salt (ionic molten material) containing lithium ions, polymer solid electrolyte, inorganic solid electrolyte or the like may be used.

The cold molten salts (ionic molten material) mean compounds which can exist as a liquid at normal temperature (15 to 25° C.) among organic salts prepared from combinations of organic cations and anions. Examples of the cold molten salt include cold molten salts which exist singly as a liquid, cold molten salts which are changed into a liquid by blending it with an electrolyte, and cold molten salts which are changed into a liquid by dissolving in an organic solvent. The melting point of the cold molten salt to be used for non-aqueous electrolyte batteries is generally 25° C. or less. The organic cation generally has a quaternary ammonium skeleton.

The polymer solid electrolyte is prepared by dissolving an electrolyte in a polymer material and by solidifying the polymer material. The inorganic solid electrolyte is a solid material having lithium ion conductivity.

5) Separator

The separator is formed of porous films containing a polyethylene, polypropylene, cellulose or polyvinylidene fluoride, and nonwoven fabric made of a synthetic resin. Among these materials, a porous film made of a polyethylene or polypropylene can be melted at a fixed temperature to cut off current, making it possible to improve the safety of the battery.

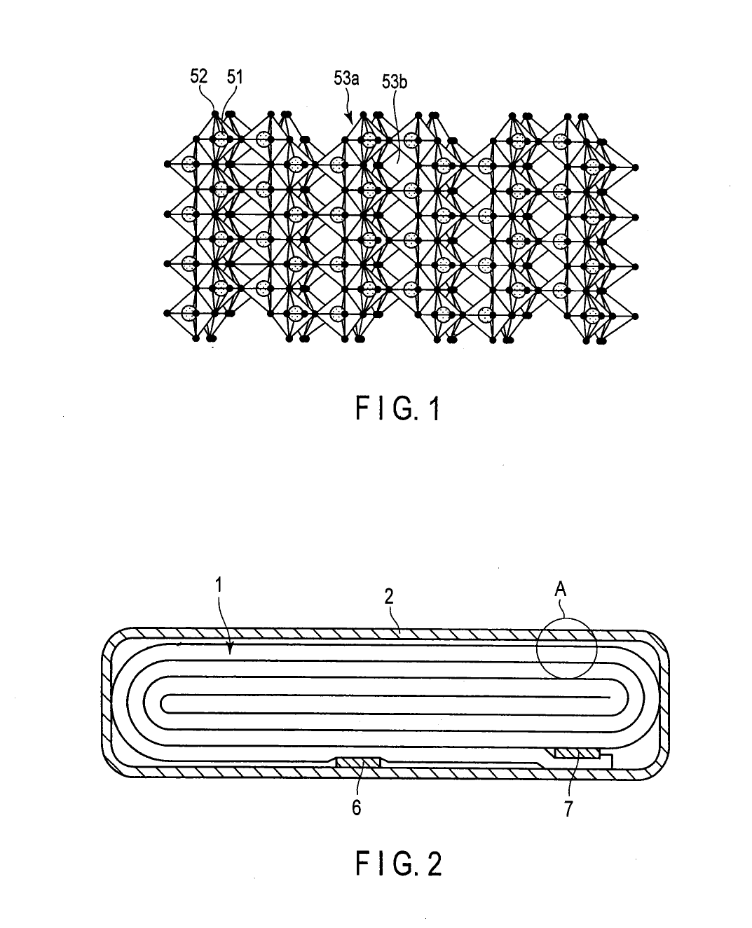

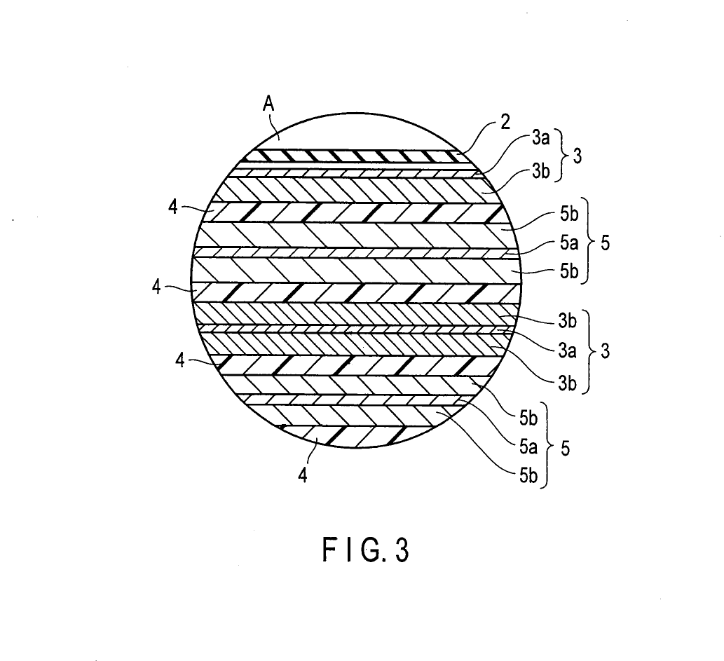

Next, the non-aqueous electrolyte battery will be explained in more detail with reference to the drawings. FIG. 2 is a sectional view of a flat type non-aqueous electrolyte battery and FIG. 3 is an enlarged sectional view of the A part of FIG. 2. Each drawing is a typical view for explaining the embodiment and for promoting the understanding of the embodiment. Although there are parts different from an actual battery in shape, dimension and ratio, these structural designs may be properly changed taking the following explanations and known technologies into consideration.

A flattened wound electrode group 1 is housed in a bag-like outer package 2 made of a laminate film obtained by interposing an aluminum foil between two resin layers. The flattened wound electrode group 1 is formed by spirally wounding a laminate obtained by laminating a negative electrode 3, a separator 4, a positive electrode 5 and a separator 4 in this order from the outside and by press-molding the coiled laminate.

The outermost negative electrode 3 has a structure in which, as shown in FIG. 3, a negative electrode layer 3b is formed on one of the inside surfaces of a negative electrode current collector 3a. Other negative electrodes 3 each have a structure in which a negative electrode layer 3b is formed on each surface of the negative electrode current collector 3a. The negative electrode layer 3b contains, as the active material, the titanium oxide compound having a crystal structure of monoclinic titanium dioxide modified with at least one ion selected from the aforementioned alkali metal cations, and as the binder, a non-fluororesin.

The positive electrode 5 has a structure comprising a positive electrode layer 5b on each side of a positive electrode current collector 5a.

In the vicinity of the outer peripheral end of the flattened wound electrode group 1, a negative electrode terminal 6 is connected to the negative electrode current collector 3a of the outermost negative electrode 3 and a positive electrode terminal 7 is connected to the positive electrode current collector 5a of the inside positive electrode 5. These negative electrode terminal 6 and positive electrode terminal 7 are externally extended from an opening part of the bag-like outer package 2. A liquid non-aqueous electrolyte is, for example, injected from the opening part of the bag-like outer package 2. The opening part of the bag-like outer package 2 is closed by heat sealing with the negative electrode terminal 6 and positive electrode terminal 7 caught in the opening part to thereby perfectly seal the flattened wound electrode group 1 and liquid non-aqueous electrolyte.

The negative electrode terminal is made of, for example, a material being electrochemically stable and having conductivity at the Li absorption/release potential of the negative electrode active material. Specific examples of the negative electrode terminal include copper, nickel, stainless, or aluminum, or an aluminum alloy containing elements such as Mg, Ti, Zn, Mn, Fe, Cu, and Si. The negative electrode terminal is preferably made of the same material as the negative electrode current collector to reduce the contact resistance with the negative electrode current collector.

The positive electrode terminal is made of, for example, a material having electric stability and conductivity in a potential range of 3.0 V or more and 5.0 V or less and preferably 3.0 V or more and 4.25 V or less with respect to a lithium ion metal. Specific examples of the material for the positive electrode terminal include aluminum and aluminum alloys containing elements such as Mg, Ti, Zn, Ni, Cr, Mn, Fe, Cu, and Si. The positive electrode terminal is preferably made of the same material as the positive electrode current collector to reduce the contact resistance with the positive electrode current collector.

### Second Embodiment

In general, according to a second embodiment, a pack battery includes one or two or more of the non-aqueous electrolyte batteries (unit cell) according to the embodiment. When a plurality of unit cells is contained, each unit cell is electrically connected in series, in parallel or in series-parallel arrangements.

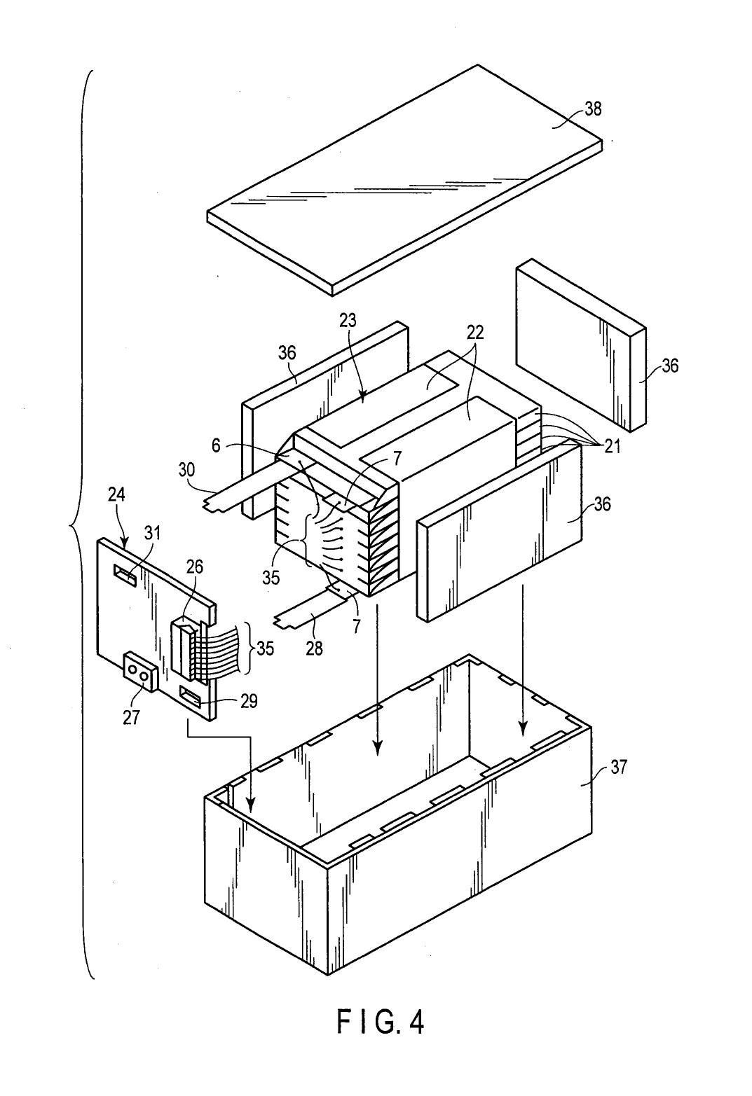

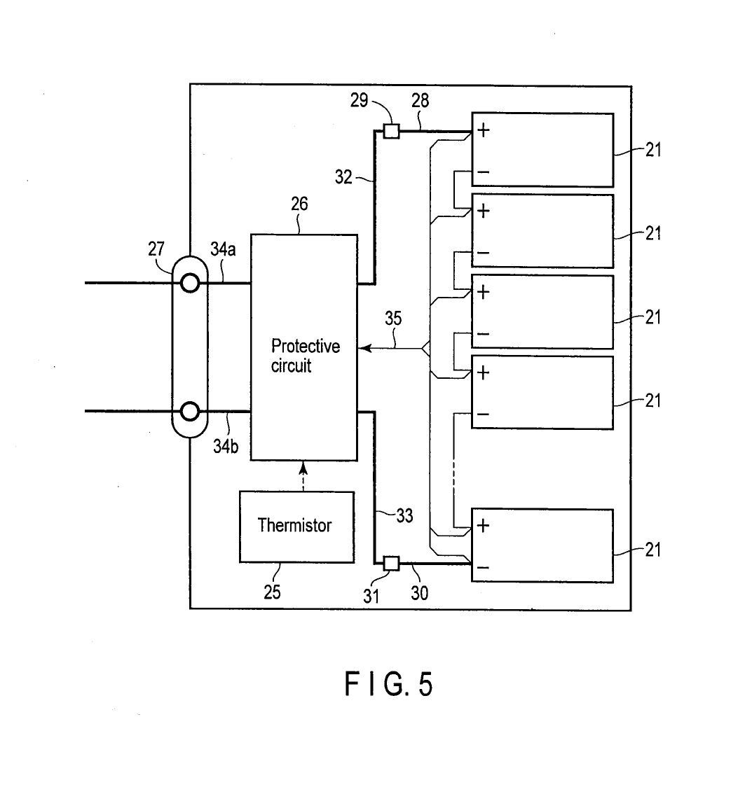

FIGS. 4 and 5 show an example of a pack battery including a plurality of flat-type batteries shown in FIG. 2. FIG. 4 is an exploded perspective view of a pack battery. FIG. 5 is a block view showing the electric circuit of the pack battery of FIG. 4.

A plurality of unit cells 21 each constituted of the flat type non-aqueous electrolyte battery shown in FIG. 2 are laminated such that the negative electrode terminals 6 and positive electrode terminals 7 extended externally are arranged in the same direction and then fastened with an adhesive tape 22 to thereby constitute a battery assembly 23. These unit cells 21 are electrically connected with each other in series as shown in FIG. 4.

A printed circuit board 24 is disposed opposite to the side surface of the unit cell 21 from which the negative electrode terminal 6 and positive electrode terminal 7 are extended. As shown in FIG. 4, a thermistor 25, a protective circuit 26 and a conducting terminal 27 that conducts electricity to external devices are mounted on the printed circuit board 24. In this case, an insulating plate (not shown) is attached to a protective circuit substrate 24 facing the battery assembly 23 to avoid unnecessary connections with the wiring of the battery assembly 23.

A positive electrode side lead 28 is connected to the positive electrode terminal 7 positioned at the lowermost layer of the battery assembly 23 and the top of the lead 28 is inserted into and electrically connected to a positive electrode side connector 29 of the printed circuit board 24. A negative electrode side lead 30 is connected to the negative electrode terminal 6 positioned at the uppermost layer of the battery assembly 23 and the top of the lead 30 is inserted into and electrically connected to a negative electrode side connector 31 of the printed circuit board 24. These connectors 29 and 31 are connected to the protective circuit 26 through traces 32 and 33 formed on the printed circuit board 24.

The thermistor 25 is used to detect the temperature of the unit cell 21 and the detected signals are transmitted to the protective circuit 26. The protective circuit 26 can shut off a positive-side wire 34a and a negative-side wire 34b between the protective circuit 26 and the conducting terminal 27 used to conduct electricity to external devices, in a predetermined condition. The predetermined condition means, for example, the case where the temperature detected by the thermistor 25 exceeds a predetermined temperature. Further, the predetermined condition means the case of detecting overcharge, overdischarge, over-current and the like of the unit cell 21. This over-current or the like is detected with respect to individual unit cells 21 and the whole unit cells 21. When the over-current and the like of individual unit cells 21 are detected, either the voltage of the battery may be detected or the potential of the positive electrode or negative electrode may be detected. In the case of the latter, a lithium electrode to be used as the reference electrode is inserted into each unit cell 21. In the case of FIG. 4 and FIG. 5, a wire 35 that detects voltage is connected to each unit cell 21 and the detected signals are transmitted to the protective circuit 26 through these wires 35.

A protective sheet 36 made of a rubber or resin is disposed on each of the three sides of the battery assembly 23 excluding the side from which the positive electrode terminal 7 and negative electrode terminal 6 are projected.

The battery assembly 23 is accommodated in a receiving container 37 together with each protective sheet 36 and the printed circuit board 24. Specifically, the protective sheet 36 is disposed on each of the both inside surfaces of the long side of the receiving container 37 and the inside surface of the short side of the receiving container 37, and the printed circuit board 24 is disposed on the opposite inside surface of the short side of the receiving container 37. The battery assembly 23 is disposed in a space enclosed with the protective sheet 36 and printed circuit board 24. The lid 38 is set to the upper surface of the receiving container 37.

In this case, a thermal shrinkage tube may be used in place of the adhesive tape 22 to secure the battery assembly 23. In this case, a protective sheet is disposed on each side of the battery assembly and the thermal shrinkage tube is wound. Then, the thermal shrinkage tube is thermally shrunk to fasten the battery assembly.

Although FIG. 4 and FIG. 5 show the structure in which the unit cells 21 are connected in series, the unit cells 21 may be connected in parallel or in series-parallel assemblies to increase the capacity of the battery. The assembled pack batteries may be further connected in series or in parallel.

Further, the structure of the pack battery is properly changed according to its application. The applications of the pack battery are preferably those for which cycle characteristics in large-current characteristics are desired. Specific examples of these applications include power sources for digital cameras and vehicle applications such as two- or four-wheel hybrid electric vehicles, two- to four-wheel electric vehicles and electric mopeds. The pack battery is preferably mounted on vehicles.

### EXAMPLES

The embodiment will be explained in more detail by way of examples. In this case, the crystal phase obtained by the reaction was identified, the crystal structure was estimated according to the powder X-ray diffraction method using Cu—Kα-rays, and the specific surface area was measured by the BET method shown in the first embodiment. Further, the composition of a product was analyzed by the ICP method to confirm that an object product was obtained.

<Synthesis of a Modified Titanium Oxide Compound>

First, commercially available K₂Ti₄O₉ was prepared as a raw material. The K₂Ti₄O₉ powder was washed with distilled water to remove impurities. This powder was added in a 1 M hydrochloric acid solution, and then stirred at 25° C. for 72 hours to perform proton exchange. At this time, the 1 M hydrochloric acid solution was replaced with a new one every 24 hours.

The suspension solution obtained by the proton exchange had high dispersibility and therefore separation by filtration was not easy. Because of this, the suspension solution was centrifuged to separate a solvent from a solid, thereby obtaining a proton titanate compound represented by the formula H₂Ti₄O₉. A powder of this proton exchange body was washed with pure water until the pH of the washed solution was 6 to 7.

Then, the proton exchange body (H₂Ti₄O₉) was sintered at 350° C. for 3 hours. To obtain an exact heat history, the proton exchange body was placed in an electric furnace kept at a predetermined temperature, heated, and then immediately taken out of the furnace to rapidly cool in the air. This sintered product was dried at 80° C. under vacuum for 12 hours to obtain titanium oxide compound.

The obtained titanium oxide compound was measured by powder X-ray diffraction using Cu—Kα-rays to confirm that the synthesized titanium oxide compound had a TiO₂ (B) crystal structure.

The powder X-ray diffraction of the active material is measured in the following manner. First, an object sample is ground until the average particle diameter reaches about 5 μm. The average particle diameter can be found by the laser diffraction method. The ground sample is filled in a holder part which is formed on a glass sample plate and has a depth of 0.2 mm. At this time, much care is necessary to fill the holder part sufficiently with the sample. Further, special care should be taken to avoid cracking and formation of voids caused by insufficient filling of the sample. Then, a separate glass plate is used to smooth the surface of the filling sample by sufficiently pressing the separate glass plate against the sample. Much care should be taken to fill the right amount of the sample, thereby preventing any rise and dent from the basic plane of the glass holder. Then, the glass plate filled with the sample is set to a powder X-ray diffractometer to obtain a diffraction pattern using Cu—Kα-rays.

When the sample has high orientation as shown in the case where the ratio of a specified peak intensity deviates 50% or more from the ratio of the standard peak intensity described in the JCPDS card which is a data base of standard minerals in the powder X-ray diffraction pattern, there is the possibility that the position of a peak is shifted and the ratio of intensities is varied depending on the way of filling the sample. Such a sample is measured after it is made into a pellet form. The pellet may be a compressed body having, for example, a diameter of 10 mm and a thickness of 2 mm. The compressed body may be manufactured under a pressure of about 250 MPa for 15 minutes. The obtained pellet is set to the X-ray diffractometer to measure the surface of the compressed powder. The measurement using such a method ensures that a difference in the measurement result between operators is eliminated, so that the reproducibility can be improved.

Then, the obtained titanium oxide compound having a TiO₂(B) crystal structure was modified by using Na as a modifying element. 1 L of an aqueous 1 M sodium hydroxide solution was prepared and 10 g of titanium oxide compound was added in this solution, which was stirred for 1 hour. Then, a solid was separated by filtration and washed with 5 L of pure water. The obtained solid was dried at 80° C. under vacuum for 12 hours to synthesize a modified titanium oxide compound. This modified titanium oxide compound was examined by the X-ray photoelectron spectroscopy (XPS). Among the detected elements, an atomic ratio of oxygen (O) to a modifying element (Na) was 0.21 (Na):1 (O).

### Example 1

A polyacrylic acid was blended as a binder in a ratio of 10% by mass and acetylene black was blended as a conductive agent in a ratio of 10% by mass in a powder of a modified titanium oxide compound, and then a mixture was molded to produce an electrode. A metal lithium foil was used as a counter electrode of this electrode. As the non-aqueous electrolyte, a composition was used which was prepared by dissolving lithium perchlorate in a concentration of 1 M in a mixture solvent of ethylene carbonate and diethyl carbonate (ratio by vol: 1:1). These materials were used to produce an electrochemical measuring cell.

In this case, the electrode potential of the titanium oxide compound is nobler than that of the counter electrode since a lithium metal was used as the counter electrode. For this, the direction of charge/discharge is reverse to the case where a titanium oxide compound electrode is used as the negative electrode of a lithium ion battery. Here, in Example 1, the directions of charge/discharge are standardized as follows: the direction in which lithium ions are intercalated into the titanium oxide compound electrode is referred to as a charge direction whereas the direction in which lithium ions are desorbed is referred to as a discharge direction.

Although, in Example 1, the electrode using a titanium oxide compound is made to work as the positive electrode as mentioned above, an electrode using a titanium oxide compound may be, of course, made to work as the negative electrode by combining with a conventionally known positive electrode material.

### Example 2

An electrochemical measuring cell was produced in the same manner as in Example 1 except that carboxymethyl cellulose was used as the binder.

### Example 3

An electrochemical measuring cell was produced in the same manner as in Example 1 except that hydroxypropylmethyl cellulose was used as the binder.

### Comparative Example 1

In Comparative Example 1, a titanium oxide compound having a crystal structure of modified TiO₂(B) was used in the same manner as in Example 1. 10% by mass of polyvinylidene fluoride was added as a binder to this modified oxide compound to produce an electrode, which was then used to produce an electrochemical measuring cell. The same method as in Example 1 was used to produce the electrode and measuring cell.

### <Evaluation of Electrochemical Characteristics>

Each of the measuring cells prepared in Examples 1 to 3 and Comparative Example 1 was allowed to repeatedly charge/discharge 100 times (one charge/discharge: one cycle) in a 50° C. thermostat as an acceleration test to examine capacity retention ratio and coulomb efficiency. The 100 cycle-charge/discharge operation was performed at 1 C capacity and only the first discharge operation was performed at 0.2 C capacity. The capacity retention ratio was calculated when the 0.2 C discharge capacity of the first cycle was set to 100. Further, solution resistance and reaction resistance were also found from the measurement of AC impedance around 100 cycles. The results are shown in Table 1.

TABLE 1

| | | | | | 50° C. | Solution | Reaction | | |
|---|---|---|---|---|---|---|---|---|---|
| | | | | 5 C rate | discharge | resistance | resistance | 50° C. | 50° C. |
| | | | First | discharge | capacity | before | before | solution | reaction |
| | | First | charge/ | capacity | retention | repeated | repeated | resistance | resistance |
| | | discharge | discharge | retention | rate after | charge/ | charge/ | after | after |
| | | capacity | efficiency | rate | 100 cycles | discharge | discharge | 100 cycles | 100 cycles |
| | Binder | (mAh/g) | (mAh/g) | (%) | (%) | (Ω) | (Ω) | (Ω) | (Ω) |
| Example 1 | Polyacrylic acid | 217.5 | 90.1 | 66.5 | 63.5 | 3.5 | 3.0 | 5.0 | 6.0 |
| Example 2 | Carboxymethyl | 217.4 | 90.0 | 66.6 | 63.0 | 3.5 | 3.1 | 5.2 | 6.3 |
| | cellulose | | | | | | | | |
| Example 3 | Hydroxypropylmethyl | 217.3 | 90.0 | 66.3 | 62.8 | 3.5 | 3.1 | 5.3 | 6.4 |
| | cellulose | | | | | | | | |
| Comparative | Polyvinylidene | 216.3 | 89.5 | 53.0 | 42.4 | 3.5 | 8.0 | 5.0 | 29.0 |
| Example 1 | fluoride | | | | | | | | |

As is clear from Table 1, it is found that each cell obtained in Examples 1 to 3 is more improved in 5 C rate discharge capacity retention ratio and discharge capacity retention ratio after 100 charge/discharge cycles, and is more decreased in the rise of reaction resistance after 100 charge/discharge cycles compared to the cell of Comparative Example 1. Accordingly, batteries, which are limited in deterioration and capable of charge/discharge stably, can be obtained by combining a titanium oxide compound (active material) having a modified TiO₂(B) crystal structure and a polyacrylic acid (binder) as Example 1, by combining a titanium oxide compound (active material) having a modified TiO₂(B) crystal structure and a carboxymethyl cellulose (binder) as Example 2, or by combining a titanium oxide compound (active material) having a modified TiO₂(B) crystal structure and a hydroxypropylmethyl cellulose (binder) as Example 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-aqueous electrolyte battery comprising:
an outer package;
a positive electrode housed in the outer package;
a negative electrode spaced apart from the positive electrode and housed in the outer package; and
a non-aqueous electrolyte filled in the outer package,
wherein the negative electrode comprises a current collector and a negative electrode layer formed on at least one surface of the current collector, and
the negative electrode layer comprises a titanium oxide compound having a crystal structure of monoclinic titanium dioxide as an active material and a non-fluororesin, the titanium oxide compound being modified with at least one ion selected from alkali metal cations.

2. The battery according to claim 1, wherein the alkali metal cation is an ion of a Li element, Na element, or K element.

3. The battery according to claim 1, wherein an atomic ratio of an oxygen to an alkali metal in the titanium oxide compound modified with the at least one ion is 0.12 to 0.90 (alkali metal): 1 (oxygen) in analysis using the X-ray photoelectron spectroscopy.

4. The battery according to claim 1, wherein the titanium oxide compound has an aspect ratio of 1 or more and 50 or less, a length of 0.1 μm or more and 50 μm or less in the direction of the minor axis, and a length of 0.1 μm or more and 200 μm or less in the direction of the major axis.

5. The battery according to claim 1, wherein the non-fluororesin is a polyacrylic acid, a carboxymethyl cellulose, or a hydroxypropylmethyl cellulose.

6. The battery according to claim 1, wherein the active material and the non-fluororesin in the negative electrode layer are contained in amounts of 68% by mass or more and 96% by mass or less, and 2% by mass or more and 30% by mass less, respectively.

7. The battery according to claim 1, wherein the active material further contains at least one other titanium oxide compound selected from the group consisting of anatase type titanium dioxide, rhamsdelite type lithium titanate, and spinel type lithium titanate.

8. A pack battery comprising the battery as claimed in claim 1.

9. The pack battery according to claim 8, the pack battery further comprising a protective circuit.
